(19) United States
(12) Patent Application Publication
(10) Pub. No.: US 2025/0146613 A1
(43) Pub. Date: May 8, 2025

(54) AN OUTLET PIPE AND A METHOD FOR ASSEMBLING

(71) Applicant: VALMET FLOW CONTROL OY, Vantaa (FI)

(72) Inventor: Jussi HELLMAN, Vantaa (FI)

(73) Assignee: VALMET FLOW CONTROL OY, Vantaa (FI)

(21) Appl. No.: 18/837,658

(22) PCT Filed: Feb. 10, 2023
(86) PCT No.: PCT/FI2023/050081

§ 371 Date: Aug. 12, 2024

(30) Foreign Application Priority Data
Feb. 10, 2022 (FI) 20225117

(51) Int. Cl. F16L 57/06; F16L 55/045

(52) U.S. Cl. CPC F16L 57/06; F16L 55/045

(57) ABSTRACT

An outlet pipe includes a discharge pipe having an inlet end for receiving fluid and an outlet end for passing fluid, a connector attached to the discharge pipe to cover the inlet end, and a wear module arranged in a cavity limited by the discharge pipe and the connector. The connector has an interface surface for attachment to an outlet face of a valve providing the fluid, and the wear module has a conduit so that at least the discharge pipe and the conduit mutually define a flow channel passing fluid from the interface surface to the outlet end.

### BACKGROUND OF THE INVENTION

### Field of the Invention

This invention relates to an outlet pipe comprising a discharge pipe, a connector and a wear module.

### Description of Prior Art

In relation to numerous industrial processes in which high fluid pressures are needed, such as mineral processing, it is known to use outlet pipes for pressure reduction and control. In such processes, said fluids can be comprised of gas, liquid, or mixtures of gas and liquid in varying concentrations. In some of these processes, the fluid can also contain solid particles embedded within the gas or liquid, and the fluid can be highly corrosive and erosive. This is often the case in, for example, industrial processes related to pressure leaching of minerals, where outlet pipes are used for conveying said fluids from a leaching chamber to pressure reduction vessels. Transport pipeline solutions for such erosive conditions have been described in, for example, publications WO 2019167024 A1 and U.S. Pat. No. 10,458,446 B1.

The use of such fluids, in combination with the typically high operating pressures and fluctuating operating conditions, can create a highly demanding operating environment for the structural parts of an industrial equipment, including the outlet pipes. In such operating conditions, structural parts with high levels of corrosion and wear resistance are often required, and the parts exposed to the fluid flow typically require frequent replacement as part of equipment maintenance. This, in turn, can increase the cost of the industrial operation significantly, as large entities of the equipment may need replacement due to unacceptable levels of damage in any part of said entity.

### SUMMARY OF THE INVENTION

An object of the present invention is to alleviate the above-mentioned drawback and to provide a solution allowing for longer replacement intervals of the structural parts and more cost-efficient maintenance. This object is achieved with an outlet pipe according to independent claim 1 and a method according to independent claim 11.

By utilizing a wear module, it is possible to obtain a structure having longer replacement intervals and more cost-efficient maintenance.

Preferred embodiments of the invention are disclosed in the dependent claims.

### BRIEF DESCRIPTION OF DRAWINGS

In the following the present invention will be described in closer detail by way of example and with reference to the attached drawings, in which

FIG. 1 illustrates a cross-cut section of a first embodiment of an outlet pipe,

FIG. 2 illustrates a cross-cut section of a second embodiment of an outlet pipe,

FIG. 3 illustrates a part of a cross-cut section of a third embodiment of an outlet pipe, and

FIG. 4 illustrates a cross-cut section of a fourth embodiment of an outlet pipe.

### DESCRIPTION OF AT LEAST ONE EMBODIMENT

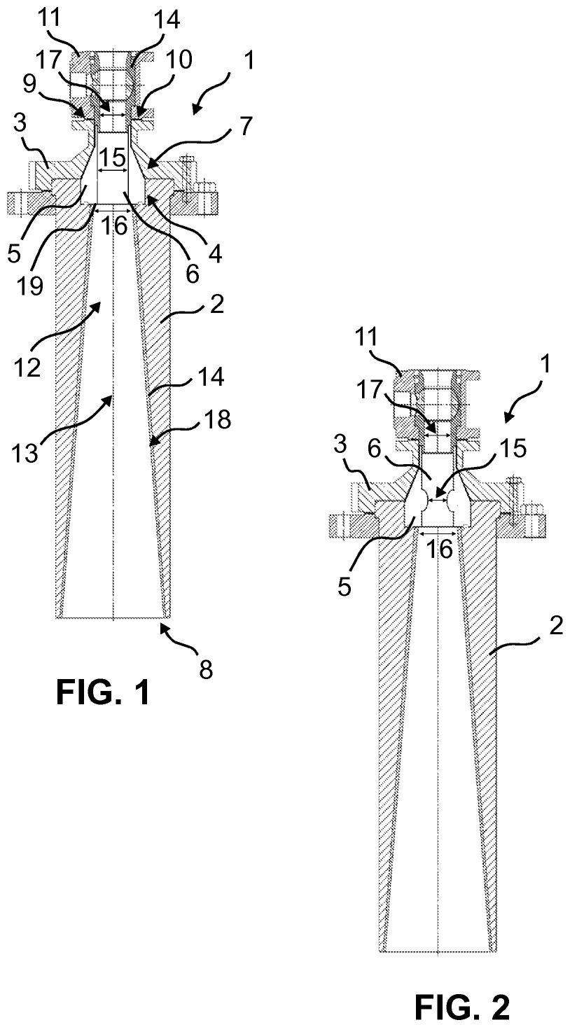

FIG. 1 illustrates a cross-cut section of a first embodiment of an outlet pipe 1, as viewed along a longitudinal middle plane of the outlet pipe. In this example, the outlet pipe 1 comprises a discharge pipe 2 and a connector 3 attached to the discharge pipe 2, so that the discharge pipe 2 and the connector 3 limit a cavity 4. In other words, the discharge pipe 2 and the connector 3 are internally shaped so that the cavity 4 is formed between them as a result of the connector 3 being attached to the discharge pipe 2. Furthermore, the outlet pipe 1 comprises a wear module 5 arranged in the cavity 4, the wear module 5 comprising a conduit 6. The discharge pipe 2 has an inlet end 7 for receiving fluid and an outlet end 8 for passing fluid, and the connector 3 is arranged to cover the inlet end 7. The connector 3 also has an interface surface 9 for attachment to an outlet face 10 of a valve 11, said valve 11 providing the fluid. The connector 3 can be a part of a pressure retaining vessel and it may be implemented as a lid structure complying to PED (Pressure Equipment Directive).

The discharge pipe 2 may, depending on the implementation, be a very large (such as 1-2 m long) and expensive part manufactured with a steel structure and a wear resistant inner lining. By utilizing a wear module 5 as described below, it becomes possible to ensure that the cheaper and simpler wear module 5 is subjected to a major part of the wear during use, such that it is in most cases sufficient to replace only the wear module 5 instead of the entire discharge pipe 2, during maintenance operations.

In the example of FIG. 1, the discharge pipe 2 and the conduit 6 of the wear module 5 mutually define a flow channel 12 passing the fluid from the interface surface 9 of the connector 3 to the outlet end 8 of the discharge pipe 2. In other embodiments, however, other parts of the outlet pipe 1, such as the connector 3, may also be used to mutually define the flow channel 12 with the discharge pipe 2 and the conduit 6. In other words, said other parts may also form a contact surface with the fluid passing from the interface surface 9 to the outlet end 8. Furthermore, in the example of FIG. 1, the discharge pipe 2 and the connector 3 limit the cavity 4 so that the cavity 4 extends in both of the discharge pipe 2 and the connector 3. However, this arrangement may differ in other embodiments of the outlet pipe 1, wherein the cavity 4 may extend only in the structure of the discharge pipe 2 or the connector 3, for example.

In the example of FIG. 1, the outlet pipe 1 has also been arranged in a vertical position so that the flow channel 12 extends in the direction of the gravitational force. This arrangement may be beneficial compared to, for example, an arrangement in which the outlet pipe 1 has been arranged horizontally, as it allows the asymmetry caused by the gravitational force on the fluid flow within the flow channel 12 to be avoided. This, in turn, may have a favorable influence on the lifespan of the outlet pipe 1 by promoting more uniform wear on the flow channel 12 by the fluid flow.

In the example of FIG. 1, the wear module 5 and the cavity 4 are mutually shaped to prevent movement of the wear module 5 in the axial and radial directions of the flow channel 12. That is, an outer surface of the wear module 5 has been shaped to be form-fitting to the cavity 4, thereby abutting the walls of the cavity 4 in both axial and radial directions. In this example, the outer surface of the wear module 5 is also shaped to be circularly symmetric around the center axis 13 of the flow channel 12 to allow free rotation of the wear module 5. This arrangement is beneficial, as it allows the wear module 5 to be rotated around the center axis 13, for example during a maintenance procedure of the outlet pipe 1, to accommodate for possible asymmetrical wear or corrosion on the wear module 5. After said rotation, the wear module 5 can be locked to the desired position by, for example, using locking parts. Such asymmetrical wear or corrosion can occur, for example, as a result of asymmetrical fluid flow pattern within the flow channel 12, which in turn may be caused, for example, by asymmetrical shape of the flow system to which the flow channel 12 is connected. An asymmetrical flow pattern may also be caused by an asymmetrical opening through the valve 11, which may occur particularly when small opening angles of the valve 11 are used, in which case the fluid flow passing a movable closure member in the valve 11 is directed sideways in relation to the center axis 13 of the flow channel.

The cavity 4 and the wear module 5 of FIG. 1 may also be simply modified in other embodiments of the outlet pipe 1 so that the cavity 4 and the wear module 5 are mutually shaped to allow the wear module 5 to be arranged in the cavity 4 only in a few predetermined angle orientations around the center axis 13 of the flow channel 12. Such modification may be accomplished by, for example, providing the walls of the cavity 4 with additional rotation-limiting parts engaging corresponding receptors provided on the wear module 5, or by providing a rotation-limiting shape directly to the cavity 4 and the wear module 5. Such rotation-limiting parts and shapes may include, for example, pins arranged to engage corresponding recesses or step formations arranged to engage mating step formations. In case it turns out that the inner side wall of the wear module 5, due to an asymmetrical flow pattern, is subjected to a higher level of wear in a sector extending over 100°, for example, it may be sufficient that the cavity 4 and the wear module 5 are mutually shaped to allow the wear module 5 to be arranged in 3 different angle orientations with 120° separation from each other. With such arrangement, each time the inner side wall in one of the 120° sectors is worn significantly, the wear module 5 may during a maintenance procedure be rotated by 120°. Consequently, replacement of the wear module 5 may in said case be postponed until the inner side wall in all of the 3 different 120° sectors has worn out.

With an arrangement as described, an additional benefit can be obtained by enabling different properties to be implemented on different areas of the wear module 5, corresponding to different predetermined angle orientations. This may be beneficial when, for example, the properties of the fluid flow through the conduit 6 or the fluid itself are altered between process cycles or steps, in which case the wear module 5 can be positioned accordingly to a desired angle orientation between said process cycles or steps. Such properties of the wear module 5 can include, for example, material properties related to wear and corrosion resistance. The benefit of said arrangement is particularly evident in case of a changingly asymmetrical fluid flow pattern within the flow channel 12, as the desired properties of the wear module 5 can be targeted to an area most impacted by the fluid flow at each process cycle or step. In some embodiments of the outlet pipe 1, the different properties may be implemented on different areas of the wear module 5 by forming said areas of a different material. Yet in other embodiments, the wear module 5 may be formed of several individual pieces of different materials joined together to achieve the complete form of the wear module 5.

In the example of FIG. 1, the outlet pipe 1 further comprises the valve 11, the outlet face 10 of the valve attaching to the interface surface 9 of the connector 3 to connect the valve 11 as an integral part of the flow channel 12. In this example, both the discharge pipe 2 and the valve 11 further comprise an inner lining 14 covering the flow channel 12, the inner lining 14 forming a gapless interface with the wear module 5. The term ‘gapless’ in this context refers to an arrangement in which the interface between the inner lining 14 and the wear module 5 does not permit the material underlying the inner lining 14 to be exposed to the flow channel 12. However, in some embodiments of the outlet pipe 1 it may be enough to provide the inner lining 14 only on one of the discharge pipe 2 and the valve 11. In some embodiments of the outlet pipe 1, the inner lining 14 may be formed of the same material as the wear module 5, while in other embodiments, the inner lining 14 may be formed of a different material.

FIG. 2 illustrates a cross-cut section of a second embodiment of an outlet pipe 1, as viewed along a longitudinal middle plane of the outlet pipe. In praxis, this embodiment shares most of the distinguishing features of the embodiment of FIG. 1, and therefore only the differences between said embodiments are discussed here. In the examples of both FIGS. 1 and 2, the conduit 6 has a minimum inner diameter 15 that is smaller than the minimum inner diameter 16, 17 of at least one of the discharge pipe 2 and the valve 11. In this context, the term ‘minimum inner diameter of the valve 11’ refers to the part of the valve 11 which is located after the closure member in the flow direction. More precisely, in the example of FIG. 1, the conduit 6 has a constant inner diameter throughout the whole length of the conduit 6, said inner diameter being smaller than the minimum inner diameter 17 of the valve 11. In the example of FIG. 2, on the other hand, the conduit 6 has a variable inner diameter along the length of the conduit 6, having the minimum inner diameter 15 smaller than either one of the minimum inner diameter 16 of the discharge pipe 2 and the minimum inner diameter 17 of the valve 11. Also, in this example the inner diameter of the conduit 6 is variable in such a way that the conduit 6 has the minimum inner diameter 15 at an intermediate location where the diameter is smaller than at an inlet and an outlet part of the conduit 6.

By arranging the minimum inner diameter 15 of the conduit 6 according to one of the examples of FIGS. 1 and 2, it is possible to influence the fluid flow within the flow channel 12 so that flow velocity is higher at the conduit 6 than at either one of the discharge pipe 2 and the valve 11. In such case, also the eroding influence of the fluid flow may be arranged to concentrate on the wear module 5, instead of either of the discharge pipe 2 and the valve 11. In other words, by said arrangement, the wear module 5 may be arranged as a sacrificial component within the outlet pipe 1, thereby enabling the other parts forming the flow channel 12 to be used with longer replacement intervals. In such case, only the wear module 5 may need relatively frequent replacement as part of the maintenance of the outlet pipe 1. Additionally, by arranging the conduit 6 with a variable inner diameter along the length of the conduit 6, as illustrated in FIG. 2, the fluid flow may be further influenced in order to, for example, reduce the impact of the fluid flow on a certain portion of the flow channel 12.

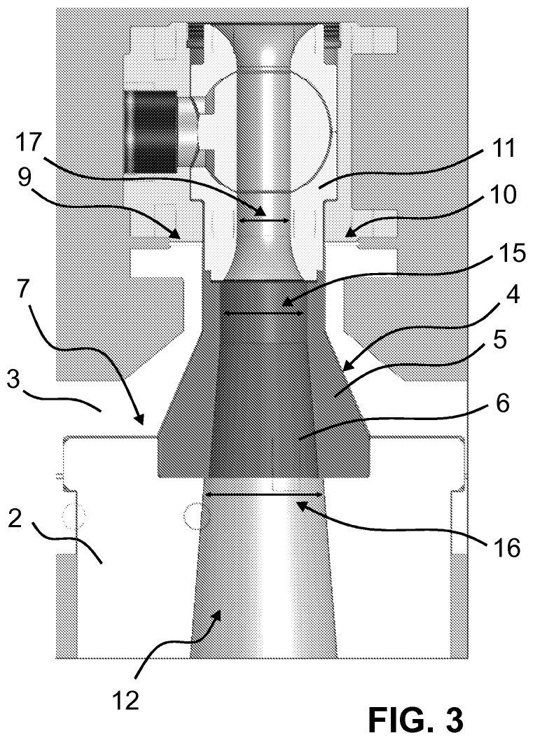

FIG. 3, which illustrates a part of a cross-cut section of a third embodiment of an outlet pipe 1, differs from the examples of FIGS. 1 and 2 in that the conduit 6 has a partially conical shape, with an inner diameter increasing towards the outlet end 8 of the discharge pipe 2. Furthermore, in the example of FIG. 3, the minimum inner diameter 15 of the wear module 5 is not smaller than the minimum inner diameter 17 of the valve 11, which may also be a suitable design option for certain operating conditions in which the outlet pipe 1 is utilized.

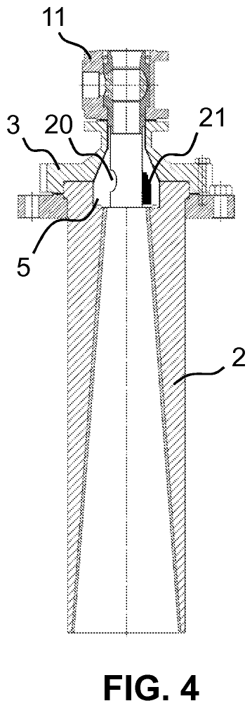

FIG. 4 illustrates a cross-cut section of a fourth embodiment of an outlet pipe 1, as viewed along a longitudinal middle plane of the outlet pipe. In this example, the conduit 6 of the wear module 5 has a discontinuing section 20 on a part of a circumferential inner surface of the conduit 6 providing an altered cross-sectional area for a fluid flow through the conduit 6 compared to the other parts of the conduit 6. In other words, the discontinuing section 20 has been arranged to extend only to a part of the inner surface of the conduit 6 along the circumference of said inner surface at a predetermined location. In this example, the discontinuing section 20 has been arranged to the conduit 6 in the form of a protrusion, causing the cross-sectional area for the fluid flow to be decreased at said location. However, the discontinuing section 20 may also be arranged as a recess, causing the cross-sectional area for the fluid flow to be increased. The discontinuing section 20 is located such that when the wear module 5 is in a predetermined angle orientation, the discontinuing section performs a desired manipulation of the fluid flow. Such desired manipulation may include, for example, directing the fluid flow in a desired manner to, for example, reduce the impact of the fluid flow on a certain portion of the flow channel 12. In said example, the outer shape of the wear module 5 has been formed so that it only allows the wear module 5 to be arranged to the outlet pipe 1 in one or more of the said predetermined angle orientations.

In the example of FIG. 4, the conduit 6 further comprises a section 21 comprising a different material compared to the other sections of the conduit 6, said section 21 providing higher wear resistance properties to the conduit 6. Such a section 21 may be used in combination with the above-mentioned discontinuing section 20, or alternatively, in an implementation where no discontinuing section 20 is present. In some implementations, it is also possible to include only a discontinuing section 20 without any section 21 providing higher wear resistance as compared to other parts of the wear module.

In the example illustrated in FIG. 4 it is, however, by way of example assumed that the outlet pipe is provided with both a discontinuing section 20 and a section 21 providing higher wear resistance properties.

In FIG. 4, the section 21 is located such that when the wear module 5 is in a specific one of the predetermined angle orientations, the fluid flow through the conduit 6 is directed towards the at least one section 21 with the highest wear resistance. This directing may be accomplished with a discontinuing section 20, if such a discontinuing section is provided to the outlet pipe 1 which is not the case in all implementations, or alternatively, due to other factors of the design, such as due to the design of the valve 11 and the closure member of the valve, for instance. The benefit of said arrangement is that it enables the section 21 to be located where most needed to ensure that the best wear resistance is achieved at the location where the erosion is highest due to the potentially asymmetrical shape of the fluid flow. This way, only a part of the wear module 5 needs to be manufactured of the material with higher wear resistance properties, which enables the wear module 5 to be produced more affordably compared to a situation in which the whole wear module 5 was manufactured of said material. In other embodiments of the wear module 5, the conduit 6 may also comprise several sections 21 comprising a different material compared to the other sections of the conduit 6, and the sections 21 may be included and positioned at the conduit 6 independently of the possibly included discontinuing section 20.

In the examples of FIGS. 1 to 4, the discharge pipe 2 has an inner surface 18 with a conical shape widening towards the outlet end 8, and the wear module 5 abuts the discharge pipe 2 in the axial direction of the flow channel 12 to form a step 19 descending towards the outlet end 8. In other words, in said examples the inner diameter of the conduit 6 at the interface between the discharge pipe 2 and the wear module 5 is smaller than the inner diameter of the discharge pipe 2 at said interface, the step 19 being thereby formed extending between the edges of the conduit 6 and the inner surface 18 of the discharge pipe 2 at said interface. Said arrangement enables the wear module 5 to act as a protective flow guide, guiding the core of the fluid flow away from the inner surface 18 of the discharge pipe 2, thereby reducing the impact of the fluid flow on the inner surface 18. With said arrangement, the lifespan of the discharge pipe 2 bay be further extended.

When assembling the outlet pipe 1 according to the embodiments of FIGS. 1 to 4, the wear module 5 is arranged to the cavity 4 so that the flow channel 12 passing fluid from the interface surface 9 of the connector 3 to the outlet end 8 of the discharge pipe 2 is provided. The wear module 5 may first be arranged into contact with the internal shape of either the discharge pipe 2 or the connector 3 mutually defining the cavity 4, after which the connector 3 is attached to the discharge pipe 2 to cover the inlet end 7. At this point, the wear module 5 comes into contact with the internal shape of also the other one of the discharge pipe 2 and the connector 3 so that the conduit 6 mutually with at least the discharge pipe 2 define the flow channel 12. The outlet pipe 1 so formed may then be attached to the outlet face 10 of the valve 11 by the interface surface 9 of the connector 3, or the valve 11 may be attached to the connector 3 at any other point of the assembly process.

The wear module 5 as described may be manufactured of, for example, a metallic material, a ceramic material or a combination of thereof in the form of, for example, a metal matrix composite, and different portions of the wear module 5 may also be formed of different materials. The wear module 5 may be manufactured using, for example, a powder metallurgical method, such as a sintering method or an additive manufacturing method, and said methods may be used in combination with the hot isostatic pressing (HIP) method.

It is to be understood that the above description and the accompanying figures are only intended to illustrate the present invention. It will be obvious to a person skilled in the art that the invention can be varied and modified without departing from the scope of the invention.

1-14. (canceled)

15. An outlet pipe, which outlet pipe comprises:
a discharge pipe having an inlet end for receiving fluid and an outlet end for passing fluid,
a connector attached to the discharge pipe to cover the inlet end, the connector having an interface surface for attachment to an outlet face of a valve providing the fluid, and
a wear module arranged in a cavity limited by the discharge pipe and the connector, the wear module having a conduit, wherein
at least the discharge pipe and the conduit mutually define a flow channel passing fluid from the interface surface to the outlet end.

16. The outlet pipe according to claim 15, wherein the cavity extends into at least one of the discharge pipe and the connector.

17. The outlet pipe according to claim 15, wherein the wear module and the cavity are mutually shaped to prevent movement of the wear module in the axial and radial directions of the flow channel.

18. The outlet pipe according to claim 15, wherein the outlet pipe further comprises the valve, the outlet face of the valve attaching to the interface surface of the connector to connect the valve as an integral part of the flow channel.

19. The outlet pipe according to claim 18, wherein at least one of the discharge pipe and the valve further comprises an inner lining covering the flow channel, the inner lining forming a gapless interface with the wear module.

20. The outlet pipe according to claim 15, wherein the conduit has a minimum inner diameter that is smaller than the minimum inner diameter of at least one of the discharge pipe and the valve.

21. The outlet pipe according to claim 15, wherein the conduit has a minimum inner diameter at an intermediate location where the diameter is smaller than at an inlet and an outlet part of the conduit.

22. The outlet pipe according to claim 15, wherein the discharge pipe has an inner surface with a conical shape widening towards the outlet end, and
that the wear module abuts the discharge pipe in the axial direction of the flow channel to form a step descending towards the outlet end.

23. The outlet pipe according to claim 15, wherein the cavity and the wear module are mutually shaped to allow the wear module to be arranged in the cavity only in a few predetermined angle orientations around the center axis of the flow channel.

24. The outlet pipe according to claim 15, wherein the wear module is manufactured using at least one of a powder metallurgical method and a hot isostatic pressing method.

25. A wear module for an outlet pipe, wherein the wear module has a conduit and an outer shape that allows the wear module to be arranged to the outlet pipe only in one or more predetermined angle orientations.

26. A wear module according to claim 25, wherein the conduit has a discontinuing section on a part of a circumferential inner surface of the conduit providing an altered cross-sectional area for a fluid flow through the conduit compared to the other parts of the conduit, and
that the discontinuing section is located such that when the wear module is in a predetermined angle orientation, the discontinuing section performs a desired manipulation of the fluid flow.

27. A wear module according to claim 25, wherein the conduit comprises at least one section comprising a different material providing higher wear resistance properties to the conduit compared to the other sections of the conduit, and
that the at least one section is located such that when the wear module is in a specific one of the predetermined angle orientations, a fluid flow through the conduit is directed towards the at least one section with the highest wear resistance.

28. A method for assembling an outlet pipe, the method comprises:
taking into use a connector having an interface surface for attachment to an outlet face of a valve,
taking into use a discharge pipe having an inlet end and an outlet end,
arranging a wear module having a conduit in a cavity limited by the discharge pipe and the connector to provide a flow channel passing fluid from the interface surface to the outlet end, and
attaching the connector to the discharge pipe to cover the inlet end.
